(19) United States
(12) Patent Application Publication
(10) Pub. No.: US 2017/0212050 A1
(43) Pub. Date: Jul. 27, 2017

(54) METHOD FOR CALIBRATING AND USING CALIBRATION OF MICROPLATES

(71) Applicant: IonField Holdings, LLC, Moorestown, NJ (US)

(72) Inventor: Paul F. Hensley, Moorestown, NJ (US)

(21) Appl. No.: 15/411,785

(22) Filed: Jan. 20, 2017

Related U.S. Application Data
(60) Provisional application No. 62/281,839, filed on Jan. 22, 2016.

(51) Int. Cl. G01N 21/64; B01L 3/00

(52) U.S. Cl. CPC G01N 21/6428; B01L 3/5085; B01L 2300/021; B01L 2300/0654

(57) ABSTRACT

A system and method to perform calibrated assays in reusable microplates, the method including steps of illuminating a microplate having wells and a microplate identifier, with a probe signal, detecting an uncalibrated return signal, reading the microplate identifier, retrieving, from a database by use of the microplate identifier, a calibration factor for each well in the microplate, calibrating the return signal for each well by use of the respective calibration factor for said well, and outputting the calibrated return signal as said calibrated assay. The system includes a microplate, comprising a plurality of wells and a microplate identifier, a reader to read the microplate identifier, a probe signal source and return signal detector, wherein a return signal comprises a probe signal after interaction with the plurality of wells, a calibration database to store the microplate identifier associated with return signal measurements, and a processor to perform the method.

### CROSS-REFERENCE TO RELATED APPLICATIONS

This application claims the benefit of U.S. Provisional Patent Application Ser. No. 62/281,839, filed on Jan. 22, 2016, the entire content of which is hereby incorporated by reference in its entirety.

### BACKGROUND

1. Field

Embodiments of the present disclosure generally relate to laboratory assay testing, and, in particular, to a system and method for calibrating and statistically optimizing assay test results from assays that use microplates and the individual wells in the microplate.

2. Description of Related Art

Within the disciplines of the clinical, industrial and life science laboratory, scientists perform methods and protocols with small quantities of fluids. These fluids consist of many categories and types with various physical properties. Many times, volumes are between a drop (about 25 microliters) and a few nanoliters. There are a number of standard methods employed to transfer liquid compounds from a source by aspirating the liquid from such fluid holding device into the fluid dispensing device having a probe, cannula, pin tool or other similar component or plurality of components which move, manually or robotically, or by use of a non-contact acoustic transfer device between a source microplate and a second destination microplate, and then dispensing, from the same probe or plurality of probes, into another fluid holding device, such as a microplate.

A microplate is a standardized flat plate with multiple wells used as small test tubes. A microplate typically has 24, 96, 384, 1536 or more sample wells arranged in a rectangular matrix of a standardized size (e.g., 127.8 millimeters (mm) by 85.5 mm). Each well of a microplate typically holds between tens of nanoliters to several milliliters of liquid. Wells in a 1536-well microplate may be spaced by 2.25 mm, and each well may have a volume of about 2 to 13 microliters of fluid, depending upon shape and depth of the well. A well cross-section is usually approximately square but can also be approximately circular. Characteristics of microplates are standardized jointly by the American National Standards Institute (ANSI) and the Society for Laboratory Automation and Screening (SLAS). Standardized footprint dimensions are promulgated by “ANSI/SLAS 1-2004: Microplates—Footprint Dimensions”. Standardized height dimensions are promulgated by “ANSI/SLAS 2-2004: Microplates—Height Dimensions”. Standardized bottom outside flange dimensions are promulgated by “ANSI/SLAS 3-2004: Microplates—Bottom Outside Flange Dimensions”. Standardized microplate well positions are promulgated by “ANSI/SLAS 4-2004: Microplates—Well Positions”. Standardized well bottom elevations are described in “ANSI/SLAS 6-2012: Microplates—Well Bottom Elevation”. ANSI SLAS 1-2004, ANSI SLAS 2-2004, ANSI SLAS 3-2004, ANSI SLAS 4-2004 and ANSI SLAS 6-2012 are all hereby incorporated by reference in their entireties.

Microplates typically are manufactured from polystyrene, but may also be manufactured from polypropylene, polycarbonate, cyclo-olefins, glass, or quartz, at least some of which are organically active.

Manufacturing limitations impose a departure from the ideal physical shape and dimensions of a microplate well. For example, there may be a tolerance or variation on physical dimensions, and the physical shape may suffer aberrations visible with an electron microscope such as pits, burrs, dimples (e.g., a wider or less-sharp protrusion than a burr), or a depression (e.g., a wider or less-sharp void than a pit). Such aberrations may be significant enough to affect laboratory results from the affected microplate well, thus making each microplate well potentially unique.

Common practice of the background art for which it is suspected that an aberration exists that is significant enough to noticeable affect testing has been to use a different microplate and rerun tests. Such a practice increases laboratory cost, delays results, and runs a risk that affected tests may go undetected if the effect is small and undermine the test results. Furthermore, because of manufacturing variations from one microplate to another, test variables are introduced (e.g., variations in well size from one microplate to another), which are uncontrolled variations in test conditions.

Therefore, a need exists to provide better control at lower cost over laboratory testing that uses microplates.

### BRIEF SUMMARY

Embodiments of the present disclosure generally relate to improved laboratory testing, and, in particular, to a system and method to calibrate assay test results using measured microplate well characteristics.

Embodiments in accordance with the present disclosure are usable to reduce plate error in assay results that are due to non-ideal or non-standard characteristics of individual microplates. Electric discharge plasma treatment of microplates reduces a standard deviation (SD) of subsequently measured parameters or assay results such as quantification cycle (C_{q}) and dynamic mass redistribution (DMR). Reductions in the SD magnitude by up to at least 50% may be possible. Embodiments include statistical methods to track and to reduce plate error.

In one embodiment, a method to calibrate a microplate and/or microplate well includes: providing a predetermined sample and assay reagent to each well of a microplate. A predetermined type of assay is performed and the assay results are then associated with the microplate and microplate well. These steps may be repeated for multiple sample profiles, type, concentrations, and/or assay types. The assay results are then stored in a calibration database, along with the identified microplate and microplate well.

In one embodiment, a method to perform an assay using calibration data includes: identifying the microplate and performing the assay to obtain raw data. Calibration data for the identified microplate and microplate well(s) is retrieved from a calibration database, and the raw data is adjusted by the calibration data. The calibrated data is then produced as the assay's results or utilized as an intermediate or guidance result in a series of assays.

Embodiments in accordance with the present disclosure include a system and method to perform calibrated assays in reusable microplates, the method including steps of illuminating a microplate having wells and a microplate identifier, with a probe signal, detecting an uncalibrated return signal, reading the microplate identifier, retrieving, from a database by use of the microplate identifier, a calibration factor for each well in the microplate, calibrating the return signal for each well by use of the respective calibration factor for said well, and outputting the calibrated return signal as said calibrated assay. The system includes a microplate, comprising a plurality of wells and a microplate identifier, a reader to read the microplate identifier, a probe signal source and return signal detector, wherein a return signal comprises a probe signal after interaction with the plurality of wells, a calibration database to store the microplate identifier associated with return signal measurements, and a processor to perform the method.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present disclosure will become apparent upon consideration of the following detailed description of embodiments thereof, especially when taken in conjunction with the accompanying drawings wherein like reference numerals in the various figures are utilized to designate like components, and wherein:

FIG. 1 illustrates a typical 1536-well microplate as known in the art;

FIG. 2 is an electron microscope photograph of a non-ideal microplate well in accordance with an embodiment of the present disclosure;

FIG. 3 is another electron microscope photograph of a non-ideal microplate well, in accordance with an embodiment of the present disclosure;

FIGS. 4A-4B are diagrams to illustrate an effect of debris in a microplate well;

FIG. 5A is a flow chart of a method to calibrate a microplate well;

FIG. 5B is a flow chart of a method to perform an assay using calibration data for a microplate well; and

FIG. 6 is a system to calibrate microplate wells and perform calibrated assays.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The exemplary systems and methods of this disclosure also may be described in relation to software, modules, and associated hardware. However, to avoid unnecessarily obscuring the present disclosure, the following description omits well-known structures, components and devices that may be shown in block diagram form, are well known, or are otherwise summarized.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

A module that performs a function also may be referred to as being configured to perform the function, e.g., a data module that receives data also may be described as being configured to receive data. Configuration to perform a function may include, for example: providing and executing sets of computer code in a processor that performs the function; providing provisionable configuration parameters that control, limit, enable or disable capabilities of the module (e.g., setting a flag, setting permissions, setting threshold levels used at decision points, etc.); providing or removing a physical connection, such as a jumper to select an option, or to enable/disable an option; attaching a physical communication link; enabling a wireless communication link; providing electrical circuitry that is designed to perform the function without use of a processor, such as by use of discrete components and/or non-CPU integrated circuits; setting a value of an adjustable component (e.g., a tunable resistance or capacitance, etc.), energizing a circuit that performs the function (e.g., providing power to a transceiver circuit in order to receive data); providing the module in a physical size that inherently performs the function (e.g., an RF antenna whose gain and operating frequency range is determined or constrained by the physical size of the RF antenna, etc.), and so forth.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes a computer readable signal medium such as a propagating signal. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Embodiments in accordance with the present disclosure are usable with plasma-treated microplates in order to increase assay sensitivity, thereby providing superior assay performance by reducing SDs and providing more discrete, statistically significant results over an assay's range of results. Doing so better exposes residual systematic errors arising from non-ideal characteristics of an individual microplate. Plasma treatment (i.e., a type of refurbishment) allows a microplate to be reused multiple times in future assays after treatment following each use. Once a microplate is restored by plasma treatment and subsequently reused, errors in wells of the microplate are more repeatable, and therefore more correctable. Systemic error is easily measured and differentiated from the remaining random error. Data indicates this systemic error has non-zero mean, and is not corrected by the size of the data set. In contrast, if a microplate is used once and thrown away, random error from the microplate remains hidden and each microplate used will contribute to error in future assays.

Embodiments to provide plasma treatment of polymers have at least four beneficial physical effects: (1) smoothing results in the surface area being reduced (2) as the surface is smoothed, the wettability of the surface increases, (3) the concentration of chemicals on the surface are reduced by plasma oxidation, and (4) light scatter is reduced as the irregular fluid-polymer interfaces are smoothed. Smoothing of the polymer surface of a microplate is a result of the plasma treatment oxidizing the more exposed raised features on the polymer surface, thereby resulting in the polymer surface having fewer and smaller surface raised features.

Individual microplate wells may have relatively large physical anomalies or aberrations. These anomalies may have the effect of: (1) altering light intensity through a decrease or increase in a Z-height of the liquid; (2) lowering the assay's dynamic range by increasing background scatter; and (3) altering results unpredictably due to small well dimensions and angularity variations in the mold and wear over thousands of molding cycles.

Embodiments in accordance with the present disclosure include a characterization method. The method may include repeating one assay or a small set of assays using a microplate, depending on a modality, which will provide data required for characterizing each well of the microplate. Embodiments may include runs of plates having matching signal levels across all wells at predetermined level(s).

Next, collected data is analyzed for deviation from ideal wells, and various models for optimization will be tested. Visualization software may be used. Artificial intelligence (AI) software also may be used to find data correlations that are not easily seen only by visualization. Well characterization may be repeated for improved microplate characterization throughout the life of a microplate.

Embodiments apply well characterization to each well as a microplate is used in subsequent assays to predict repeating errors and to identify confidence limits to prediction. Results from project plates may be compared to reference plates (e.g., identical plates in the run, or different plates within each run).

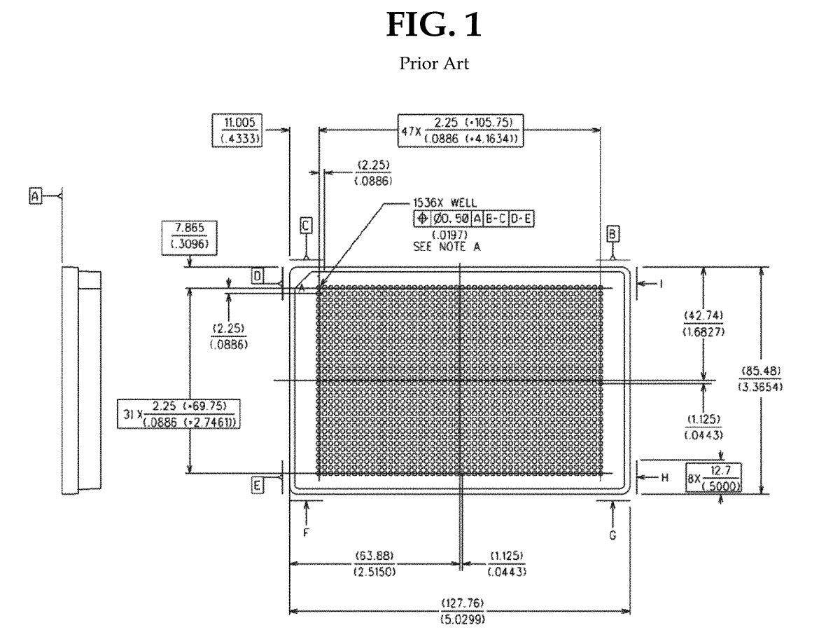

FIG. 1 illustrates a 1536-well microplate as known in the art. Dimensions are shown in units of (mm)/(inches). Systems to reuse microplates by cleaning them between usages are becoming available. Such systems may use dimethyl sulfoxide (DMSO), which is an organosulfur compound having a chemical formula (CH₃)₂SO. DMSO is a liquid polar aprotic solvent that dissolves both polar and nonpolar compounds and is miscible in a wide range of organic solvents as well as water. After treatment with DMSO, microplates may be subject to plasma treatments in order to remove any remaining DMSO or organic contaminants. Microplates may be subjected to thousands of cycles (e.g., 10,000 cycles) of usage and cleaning throughout an effective plate lifetime.

Repeated cleaning cycles may introduce changes in microplate well characteristics. For example, burrs, pits, dimples and the like may change size, shape or numbers. Portions of surface layers may erode. In some microplate wells, a portion of a surface layer may become loosened, or break off and become stuck as debris at the bottom of the microplate well. Over time, a microplate may be observed to have a coefficient of variation (CV) of certain assay results of 8% or more among microplates and/or microplate wells. CV is known in the art of statistical analysis as the standard deviation divided by the mean.

Microplates suffer from a number of limitations at a microscopic level. Their surfaces are not smooth nor are they free of chemicals that can interfere with biological assays. Their production process does not result in wells that are exactly identical, and often produces wells with aberrations large enough to affect relatively significantly an assay result (e.g., by affecting a numeric value by more than about +/−3%). The aberrations either may protrude from or plunge into a wall of a well. For example, in 1536 polystyrene microplates, it was found that even in high quality microplates, at least about 0.5% of wells have a relatively large aberration, such as surface roughness that scatters light. These large aberrations affect the optical properties of a microplate well.

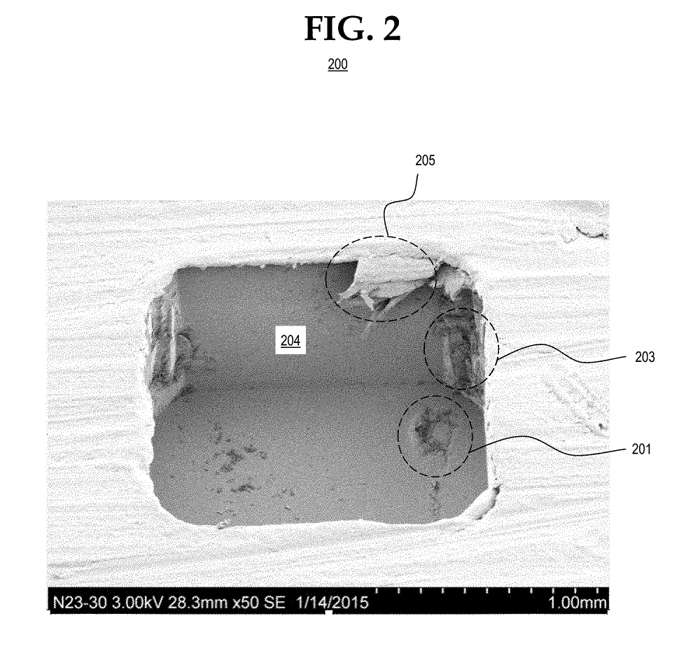

FIG. 2 is an electron microscope photograph of a microplate well 200 exhibiting several aberrations, including debris 201 and burrs 203 on a wall 204 of well 200. Such aberrations may arise during repeated cycles of usage and cleaning. Other defects such as lip defects 205 are manufacturing defects that may arise when the microplate was cut. Severe manufacturing defects may cause a microplate or microplate well to be deemed unusable.

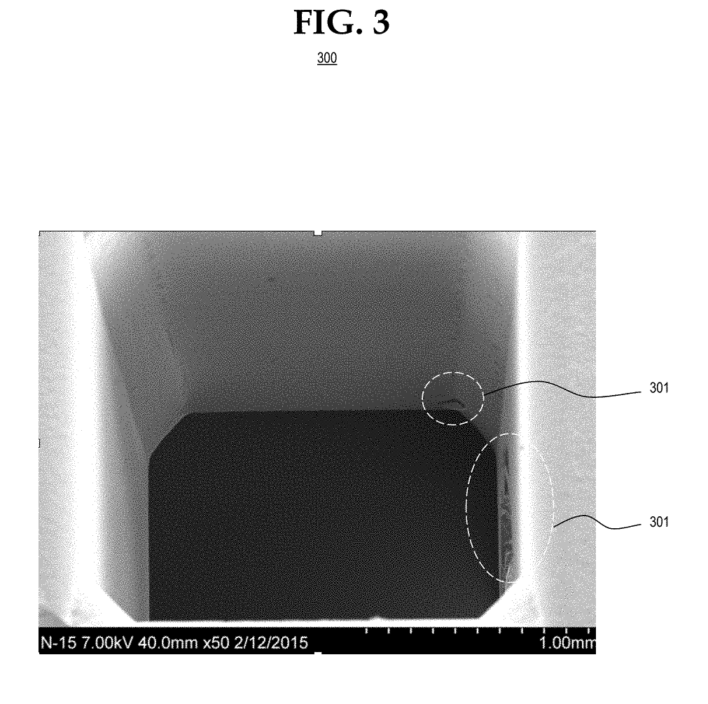

FIG. 3 is an electron microscope photograph of a microplate well 300 exhibiting other aberrations, including pits 301.

Initially, using plasma treatments during a break-in period to treat and cleanse a newly-manufactured microplate (e.g., for a break-in period of about the first ten cycles of plasma treatments for the microplate) may improve precision of assay testing by at least a threshold amount per additional treatment. Thereafter, additional treatments may provide less incremental improvement, or no incremental improvement. In some embodiments, a microplate may be pre-conditioned during a break-in period of time by a predetermined number of cycles of plasma treatment (e.g., ten cycles) prior to first usage of the microplate wells in an assay. Preconditioning in this way can help separate analytically an assay improvement due to initial break-in, from an assay improvement due to tracking and using well characterization in accordance with an embodiment of the present disclosure.

Plasma treatments do not alter well shape or large protrusions. Embodiments include apparatus and methods to characterize each well (i.e., “well characterization”), including a process to calculate correction factors that may permit adjustments of results as if the microplate wells were prefect.

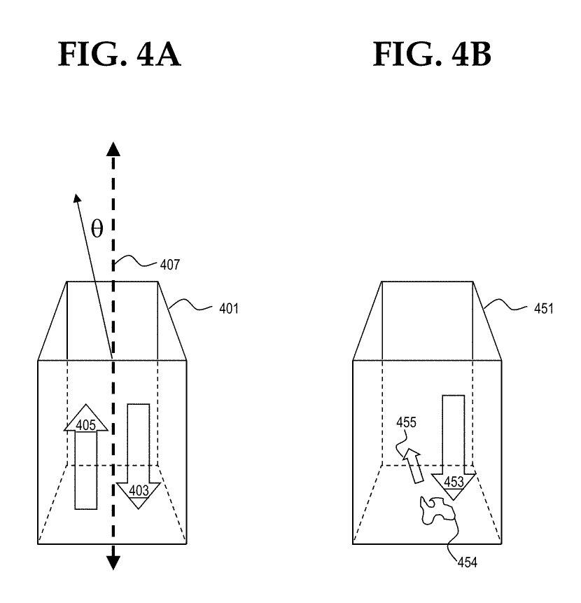

More generally, debris or other changes to the characteristics of a microplate well may cause detectable changes in a probe signal. For example, a clean microplate well that is also relatively free of aberrations may be expected to act similarly to a light-pipe when filled with certain fluids like water. As a light-pipe, light incident onto a microplate well will reflect from the bottom (i.e., the interface between the fluid and the bottom of the microplate well) and provide a relatively strong detectable return signal. The return signal may also be relatively uniform for a constant elevation angle θ around an axis of the microplate well. FIG. 4A illustrates the situation of a relatively clean and aberration-free microplate well 401. Microplate well 401 has a major axis 407. Incident signal 403 (e.g., a light beam) is reflected relatively strongly as reflected signal 405. For a constant elevation angle θ around axis 407, reflected signal 405 may be perceived as having a relatively constant intensity regardless of the azimuth angle around axis 407.

On the other hand, if debris is present at the bottom of the microplate well, an irregular interface is formed between the fluid and the bottom of the well, thus interfering with light reflection and providing a relatively weak, scattered, noncoherent or nonexistent return signal. Similarly, other changes in well characteristics (e.g., pits, burrs or other aberrations on the sides of a well) can cause changes to characteristics of return signals, such as a change in intensity or direction. Such a change may be perceived as a dark or darkened well when illuminated or as background light scatter, or other types of assay modalities in the microplate well that generate light all directions, such as fluorescence or fluorescence resonance energy transfer (FRET). A similar effect occurs for transmissive signals rather than reflected signals. Both reflected signals and transmissive signals may be referred to herein collectively as return signals unless the context clearly indicates otherwise. A return signal also may refer to a new signal (e.g., a fluorescence) generated from a probe signal. FIG. 4B illustrates the situation of a microplate well 451 having debris 454 toward the bottom of well 451. Incident signal 453 enters well 451, but reflected signal 455 is affected by debris 454, and thus is produced at a relatively smaller intensity and/or different direction compared to reflected signal 405.

Since aberrations will vary from well to well in a microplate, a return signal (including a transmissive signal) will vary from well to well, even if a same incident signal is provided to each well. Furthermore, since the cleaning process may affect aberrations in a microplate well, the return signal for a predetermined well may change over time as the number of cumulative cleanings for the microplate increase.

Embodiments in accordance with the present disclosure provide a system and method to determine individual characteristics of each microplate well. The individual characteristics may then be used as a separate calibration factor for each well, respectively, when interpreting test results from a predetermined microplate. Furthermore, since microplate well characteristics may change over time, embodiments may periodically measure characteristics of a microplate (e.g., after every cleaning, after every third cleaning, etc.), and measure trends in how the microplate well characteristics has changed in the past. From the measured changes, a conclusion may be inferred, such as a microplate having reached the end of its useful lifetime if characteristics of too many microplate wells have changed too much or too quickly.

Embodiments may include a trend prediction module to predict future microplate well characteristics (or future trends in microplate well characteristics) based upon historical measurements of microplate well characteristics (or historical trends in microplate well characteristics). The trend prediction module may extrapolate historical measurements based upon extrapolation methods known in the art. Extrapolation methods may include a linear extrapolation, a decaying exponential extrapolation, Richardson extrapolation, and Padé extrapolation. The predicted microplate well characteristics and/or predicted trends in microplate well characteristics may be used to predict a useful lifetime (e.g., as a date or as a number of usage and cleaning cycles).

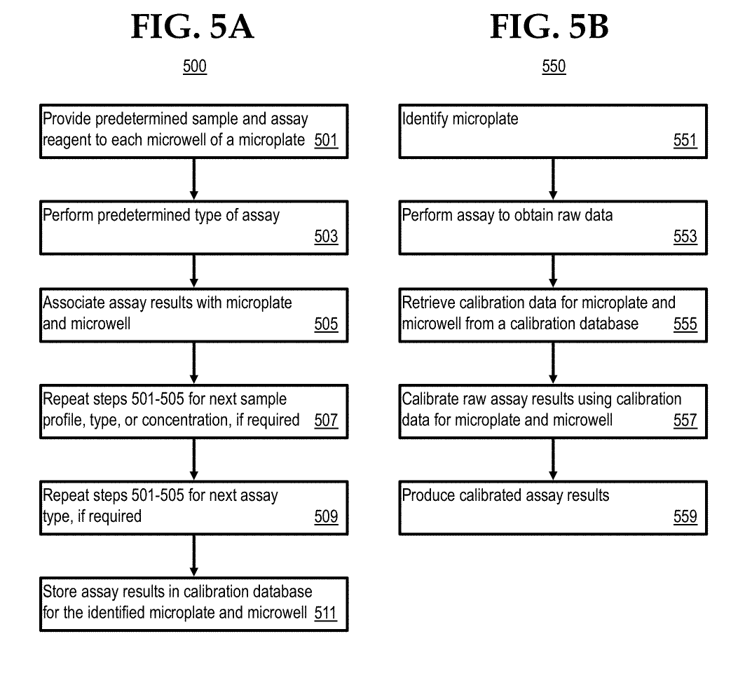

FIG. 5A illustrates a process 500 to calibrate a microplate in accordance with an embodiment of the present disclosure, by performing a series of assays. Embodiments may identify microplate well differences that are unique to each well. The differences are measured and may be used both for calibration methods and for standard methods to be run using substantially any type of microplate.

Assay sensing technology may include absorbance, luminescence, fluorescence, fluorescence polarization, fluorescence resonance energy transfer (FRET), methylation-specific quantum dot fluorescence resonance energy transfer (MS-qFRET), time resolved fluorescence (TRF), time-resolved fluorescence resonance energy transfer (TR-FRET) (e.g., homogeneous time resolved fluorescence (HTRF), LANCE®, Delfia®), FLIPR® and AlphaScreen®/AlphaLISA®, and at least some Scripps Research Institute Molecular Screening Center (SRIMSC) custom assay formats readouts, including phenotypic assays. Targets may include biochemical-based (e.g. protein-protein interactions (PPI)) and/or biological-based (i.e., cell-based screening).

Process 500 begins at step 501, at which a microplate is provided, and a predetermined sample and assay reagent is provided to substantially each microplate well. In one embodiment, each assay in the series of assays may use a substantially uniform (i.e., structurally identical) sample and assay reagents in substantially each microplate well. Exemplary samples that may be considered to be individually different but structurally identical include DNA, RNA and cells.

Next, process 500 transitions to step 503, at which a predetermined assay is performed. Next, at step 505, the assay results are associated with the specific microplate and microplate well used for the assay. For example, a microplate identification (ID) encoded in an RFID tag, barcode, QR code, optically-excited transponder, etc., can be read by a reader (e.g., RFID reader, bar code scanner, other optical detector, other non-contact reader, etc.). The microplate well number can be identified by its position in the grid. The assay results then may be associated with the microplate ID and microplate well grid position.

Next, process 500 transitions to step 507, at which in an optional embodiment, a pattern of non-identical samples or assays may be provided for each microplate well, such that differences in volume, shape, texture and other physical properties of the individual microplate wells can be measured for their individual or cumulative affect on a type of assay. For example, chemicals found in compound libraries may have little or no similarity. Often chemicals are serially diluted 10:1 over a fairly large range to determine the concentration that has a desired effect. Types of assays may include optical absorbance, fluorescence, chemiluminescence, and so forth, each of which has unique light generation characteristics and hence will have unique attenuation due to the microplate well.

Next, process 500 transitions to step 509, at which calibrations that may require multiple types of assays would be performed. The multiple assays will improve characterization of the microplate well and how the well performs with various light generation processes.

In some embodiments, calibrations may require assaying multiple sample types or concentrations of sample.

In some embodiments, calibrations may require both multiple types of assays and multiple sample types or concentrations of samples to be run.

In some embodiments, calibrations may require development of new assay types and sample types to improve sufficiently a calibration process. Methods to develop new assay types and sample types are known to those skilled in the art of methods development.

Process 500 then transitions to step 511, at which the assay results are stored in a database (e.g., a calibration database), in association with the microplate ID and a microplate well identifier (e.g., a well number, a row and column location, etc.).

FIG. 5B illustrates a process 550 to perform an assay using calibration data, in accordance with an embodiment of the present disclosure. Usage of the calibration data will allow differences in results among microplate wells to be corrected (e.g., calibrated) while collecting and/or computing measured results so that the differences among microplate wells are not included in the final results. The use of correction methods are well known to those skilled in the art of statistical analysis and similar skills.

The calibration or correction of results has numerous benefits to those running assays. Benefits include at least: (1) the results will have higher scientific confidence due to greater precision and accuracy; (2) results at very low levels of analyte (i.e., target entity) can be considered to be valid. In contrast, if results had less precision or accuracy, then results at very low levels of analyte would not necessarily considered to be valid; (3) subtle trends or results may become more apparent without measurement noise introduced by uncorrected differences among microplate wells.

Process 550 of FIG. 5 begins at step 551, at which a specific microplate is identified, e.g., by an RFID tag, barcode, QR code, or the like.

Next, process 550 transitions to step 553, at which an assay is performed. Either before, during, or after performing the assay, step 555 may be performed, at which calibration data for the microplate and microplate well(s) used in the assay is retrieved from a database, by use of the microplate identifier from step 551.

Next, process 550 transitions to step 557, at which assay data is calibrated using the calibration data for the microplate and microplate well(s) used in the assay. For example, if calibration data indicates that a specific well on a specific microplate consistently measures an assay result too low (e.g., 3% too low) compared to a control case using a different well (or compared to a consensus of a group of trusted wells), then raw data from the specific microplate well may be adjusted upward (e.g., by dividing the raw data by 0.97) in order to calibrate data from the specific microplate well. The calibration procedure may be repeated for each microplate well to be calibrated.

Next, process 550 transitions to step 559, at which calibrated assay results are produced.

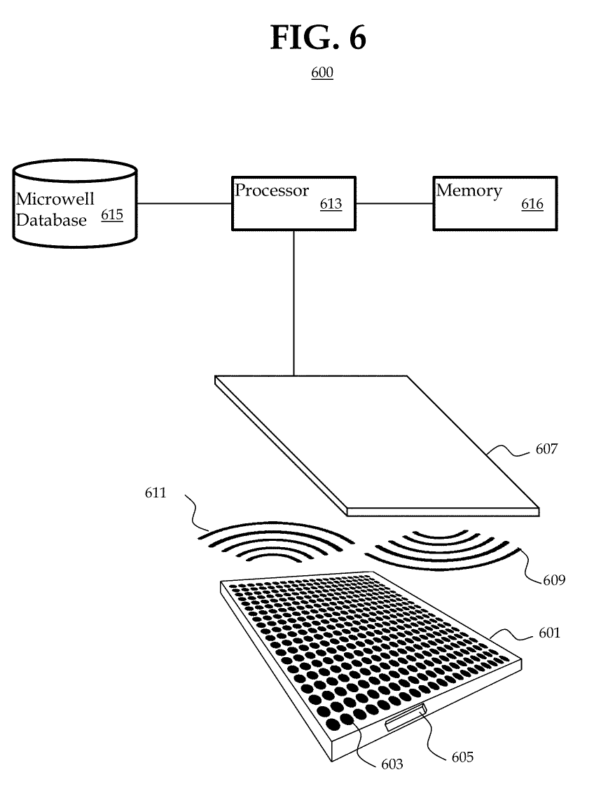

FIG. 6 illustrates a block diagram of a system 600 to calibrate microplate wells and a microplate, and perform an assay calibration, in accordance with an embodiment of the present disclosure. System 600 includes microplate 601. Microplate 601 is not drawn to scale and is not drawn with a complete set of microplate wells 603 so as not to obscure the clarity of the illustration. Microplate 601 may include an identifier 605, such as an RFID tag, barcode, QR code, or the like. Identifier 605 may be used by system 600 to track individual microplates 601, and to associate present measurements of a microplate 601 with past and future measurements of the same microplate 601.

System 600 includes a probe signal source 607, which produces a probe signal 609 (e.g., a light source). Probe signals 609 may be provided for individual microplate wells 603 (e.g., as a laser signal, either sequentially or in parallel for multiple wells respectively) or for multiple microplate wells 603 simultaneously (e.g., a light illuminating a row, a column, a rectangular grouping of multiple wells 603, the entire microplate 601, etc.). Return signal 611 is returned from each microplate well 603. Return signal 611 may depend upon the type of assay to be performed, and return signal 611 may be, e.g., a reflected signal or a transmittance signal through microplate wells.

Detectors of return signal 611 may be integrated with probe signal source 607 as illustrated in FIG. 6, or may be provided as a separate detection unit (not illustrated in FIG. 6). A separate detection unit may provide better isolation from probe signal source 607, and may allow for improved usage with certain types of assays, such as a transmittance assay.

System 600 further may include a processor 613 coupled to a microplate well database 615 and memory 616, and processor 613 further coupled to probe signal source 607, and to a return signal 611 detection unit if provided. Memory 616 may include volatile random access memory (RAM) and/or nonvolatile memory (e.g., a hard drive). Processor 613 may be configured to execute sets of program instructions stored in memory 616, in order to carry out methods described herein. For example, processor 613 may be programmed to control probe signal source 607, and to read and to process the detected return signals 611 (e.g., to produce a trend or correction factor for each microplate well). Processor 613 may be further configured to detect identifier 605 and read an identification from identifier 605, such as by interfacing to and use of an RFID reader, bar code reader, QR code reader, or the like as appropriate to the technology used to implement identifier 605.

Processor 613 may calculate a correction factor for each microplate well 603 by, e.g., computing a normalized mathematical ratio of intensity of signal 609 transmitted to each microplate well 603, divided by the light intensity of the returned signal 611 from the respective well 603. In some embodiments, it may be assumed that the same intensity of signal 609 is provided to each well 603. In other embodiments, a particularized intensity of signal 609 incident upon each respective well 603 may be measured or calculated. The ratio may be normalized by an average of substantially all functioning wells 603 (i.e., wells 603 that have not become nonfunctional due to aberrations, etc.). The calculated correction factor may then be used to adjust raw data from returned signals 611. Database 615 may store the measurement data (corrected and/or raw data), as well as the correction factor, for each respective well 603, along with the identification from identifier 605. Wells 603 may be identified by, e.g., a microplate well number, a row/column position on the microplate, etc.

By use of a correction factor individualized for each well 603 in each microplate 601, embodiments are able to computationally remove variations in test results arising from differing physical characteristics of the various wells 603. For example, if it is known from previous testing that a particular well 603 on a particular plate 601 is consistently 3% low, then future test data of that particular well 603 in that particular microplate 601 may be adjusted by dividing raw data by a correction factor of 0.97.

Embodiments in accordance with the present disclosure may include a web portal to share refurbishment and test information with customers and analysts, in particular refurbishment related to plasma treatments to clean laboratory equipment (e.g., microplates) for later reuse. Embodiments may include methods to evaluate and incorporate automatically scanning electronic microscope (SEM) photos for surface roughness and large features and ToF-SIMS for chemical content and concentration. For example, the automatic evaluation may include anomalous feature detection, feature extraction, and feature comparison to reference data (e.g., to a known good microplate or microplate well). Both SEM and ToF-SIMS are destructive methods, which would be performed on representative samples of microplates from the production lot, and used to enhance predictive analytics for the microplates.

Embodiments in accordance with the present disclosure may include developing analytics for data assessment and confidence scoring of results for each well. Embodiments may include a database to provide access and search capability of graphics results of substantially all SEM and related other graphic data. Embodiments may include secondary well and plate tracking in databases in order to track the repeated use of a microplate that may have been re-barcoded. Embodiments may include analytics to predict microplate characteristics after the next “n” refurbishments (n≧1), back test results in order to compare past predictions to actual future test results, improve prediction methods based upon back text results, and compare results within wells of a single plate.

Embodiments may include usage of artificial intelligence (AI) and machine learning modules to refine and improve a correlation of predictions to parallel plate results. As predictive accuracy increases, embodiments may include exposure of analytic modules to customers and outside analysts.

Embodiments in accordance with the present disclosure may include analytic modules to individual track chemical and physical effects, with special focus on identifying trends that indicate a change in either. Embodiments may identify one-time events and trends in data, even if the source or root cause of the events or trends is not presently known.

Embodiments of the present disclosure include a system having one or more processing units coupled to one or more memories. The one or more memories may be configured to store software that, when executed by the one or more processing unit, allows performance of embodiments described herein, including at least in FIG. 4A through FIG. 6, and related text.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present disclosure may be dependent on various considerations, such as the speed or efficiency requirements of the system, the particular function, and the particular software or hardware systems being utilized.

While the foregoing is directed to embodiments of the present disclosure, other and further embodiments of the present disclosure may be devised without departing from the basic scope thereof. It is understood that various embodiments described herein may be utilized in combination with any other embodiment described, without departing from the scope contained herein. Further, the foregoing description is not intended to be exhaustive or to limit the disclosure to the precise form disclosed. Modifications and variations are possible in light of the above teachings or may be acquired from practice of the disclosure. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the disclosure unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112(f), and any claim without the word “means” is not so intended.

I claim:

1. A system to perform calibrated assays in reusable microplates, comprising:
a microplate, comprising a plurality of wells and a microplate identifier;
a reader to read the microplate identifier;
a probe signal source and return signal detector, wherein a return signal comprises a probe signal after interaction with the plurality of wells;
a calibration database to store the microplate identifier associated with return signal measurements;
a processor coupled to the reader, to the return signal detector, to the database and to instruction memory, the processor controlled by instructions in instruction memory to perform the steps of:
reading the microplate identifier by use of the reader;
detecting an uncalibrated return signal by use of the return signal detector;
retrieving a respective calibration factor for each well in the microplate;
calibrating the return signal for each well by use of the respective calibration factor for said well; and
outputting the calibrated return signal as said calibrated assay.

2. The system of claim 1, wherein the calibration factor is derived from previous return signals.

3. The system of claim 1, further comprising a trend prediction module, to predict a trend in the calibration factor from previous return signals. The system of claim 1, wherein the return signal comprises an individual return signal for substantially each well.

5. The system of claim 1, wherein the return signal detector is positioned proximate to the probe signal source, in order to detect a reflected return signal.

6. The system of claim 1, wherein the return signal detector is positioned on an opposite side of the microplate from the probe signal source, in order to detect a transmissive return signal.

7. The system of claim 1, wherein said calibrated assay comprises assays of multiple sample types.

8. The system of claim 1, wherein said calibrated assay comprises assays of multiple concentrations of samples.

9. The system of claim 1, wherein the return signal detector comprises a detector to detect one of an absorbance, luminescence, fluorescence, fluorescence polarization and fluorescence resonance energy transfer return signal.

10. A method to perform calibrated assays in reusable microplates, comprising:
illuminating a microplate, comprising a plurality of wells and a microplate identifier, with a probe signal;
detecting, by a return signal detector, an uncalibrated return signal;
reading the microplate identifier by use of a reader;
retrieving, from a database by use of the microplate identifier, a calibration factor for each well in the microplate;
calibrating, by use of a processor, the return signal for each well by use of the respective calibration factor for said well; and
outputting the calibrated return signal as said calibrated assay.

11. The method of claim 10, further comprising the step of deriving the calibration factor from previous return signals.

12. The method of claim 10, further comprising the step of predicting a trend in the calibration factor from previous return signals. The method of claim 10, wherein the return signal comprises an individual return signal for substantially each well.

14. The method of claim 10, further comprising the step of detecting a reflected return signal by a return signal detector located proximate to the probe signal source.

15. The method of claim 10, further comprising the step of detecting a transmissive return signal by a return signal detector located on an opposite side of the microplate from the probe signal source.

16. The method of claim 10, wherein said calibrated assay comprises assays of multiple sample types.

17. The method of claim 10, wherein said calibrated assay comprises assays of multiple concentrations of samples.

18. The method of claim 10, further comprising the step of detecting, by the return signal detector, one of an absorbance, luminescence, fluorescence, fluorescence polarization and fluorescence resonance energy transfer return signal.
